(19) United States
(12) Patent Application Publication
(10) Pub. No.: US 2013/0339902 A1
(43) Pub. Date: Dec. 19, 2013

(54) METHOD AND SYSTEM FOR PROJECT OR CURRICULUM MANAGEMENT

(71) Applicant: Richard Katzman, New York, NY (US)

(72) Inventor: Richard Katzman, New York, NY (US)

(21) Appl. No.: 13/907,803

(22) Filed: May 31, 2013

Related U.S. Application Data
(60) Provisional application No. 61/653,479, filed on May 31, 2012.

(51) Int. Cl. G06F 3/0482

(52) U.S. Cl. CPC G06F 3/0482
USPC 715/810

(57) ABSTRACT

Method and system for facilitating the management of a user's projects. A user's project tracks, such as a school course track, which can be obtained by a content provider or created by the user, are presented on a display of a computing device. Each track has a time dimension and includes one or more objects positioned along the time dimension. The user is guided to perform various tasks related to the user's project tracks by a user interaction component presented on the display, which can include an avatar and an associated graphic user interface (GUI), based on a conversation format.

### CROSS REFERENCES TO RELATED APPLICATIONS

This application claims priority to U.S. Provisional Application No. 61/653,479, filed May 31, 2012, the disclosure of which is incorporated by reference herein in its entirety.

### FIELD OF THE INVENTION

The present invention relates generally to methods and systems for managing a user's “life curriculum” such as a school course via intuitive and simple graphical user interfaces.

### BACKGROUND

Tools such as MICROSOFT PROJECT are available to help a user track and display information about projects. A project in MICROSOFT can be broken down to tasks, each being represented by a timeline (including start time, end time, and duration). However, conventional project management tools tend to be complicated and non-intuitive in user graphic interface (GUI) design, and can be intimidating to users having limited technology or computer training. Further, conventional tools do not have facilities for managing a platform where contents are provided by contents providers for consumption by users.

### SUMMARY

In some embodiments, a computer-implemented method for facilitating the management of a user's project is provided. The method includes presenting, on a display of a computing device, a graphic user interface (GUI) including one or more project tracks of a user, where each track has a time dimension and including one or more objects positioned along the time dimension. The method also includes presenting on the display a user interaction component, the user interaction component interacting with the user and prompting the user for inputs, which inputs are then used to modify information displayed to the user.

The project tracks can include tracks of a variety of natures and depending on the user's age group, interest, profession, etc. In some embodiments, for a student user, the life tracks can include one or more school courses, extracurricular activities, sports, social activities, etc.

In some embodiments, the project tracks are linked to data sources and are automatically updated according to a predefined schedule. In some embodiments, the project tracks can be initially obtained (purchased, rented, subscribed, or otherwise) by or for the user from a content provider. The GUI and the user interaction component can allow the user to create and/or modify the objects on the project tracks.

In certain embodiments, the user interaction component includes an AI agent configured to be an avatar selectable by the user. In certain embodiments, the user interaction component includes an AI GUI shaped as a callout box associated with the AI agent.

In certain embodiments, the user interaction component provides a reminder regarding a future event relating to the one or more tracks to the user. In certain embodiments, in response to a user input regarding performing a task on the one or more project tracks, the user interaction component provides one or more options related to the task for the user to select. In further embodiments, in response to the user selection of one of the one or more options, the user interaction component directs the user to an environment in which an action of the selected option can be performed.

In some embodiments, a system for implementing the methods described herein is provided. The system includes a computing device having a display, a computer processor and a memory associated with the processor, the memory storing programmed instructions which, when executed by the processor, cause the processor to present on the display a graphic user interface (GUI) including one or more project tracks of a first user; and present on the display a user interaction component configured to interact with the first user to manage the first user's project tracks. An software application including the instructions can be implemented on either a user computing device or a remote server accessible by the user computing device via the Internet or other networks.

### BRIEF DESCRIPTION OF THE DRAWINGS

The foregoing summary, as well as the following detailed description of certain embodiments of the application will be better understood when read in conjunction with the appended drawings. It should be understood, however, that the application is not limited by any of the representations in the figures shown. In the drawings:

FIG. 1 is a schematic illustration of a user world GUI according to some embodiments of the invention;

FIG. 2 is an illustration of a user world GUI represented by a landscape according to some embodiments of the invention;

FIG. 3 is a schematic illustration of a content world GUI according to some embodiments of the invention;

FIG. 4 is a schematic illustration of a content world provider GUI according to some embodiments of the invention;

FIG. 5 is a diagram illustrating the connections between users and content providers according to some embodiments of the invention;

FIG. 6 is a diagram illustrating the connections between a user interaction component and relevant data according to some embodiments of the invention;

FIG. 7 is a diagram illustrating how a user interaction component follows a user on a device being used by the user according to some embodiments of the invention;

FIGS. 8a-8z and 8z-1 to 8z-6 are a series of screen shots of an exemplary interactive process between a user and an embodiment of a software application of the invention; and

FIG. 9 is a view of multiple objects from different project tracks of a user arranged by priority according to some embodiments of the invention.

### DETAILED DESCRIPTION OF CERTAIN EMBODIMENTS

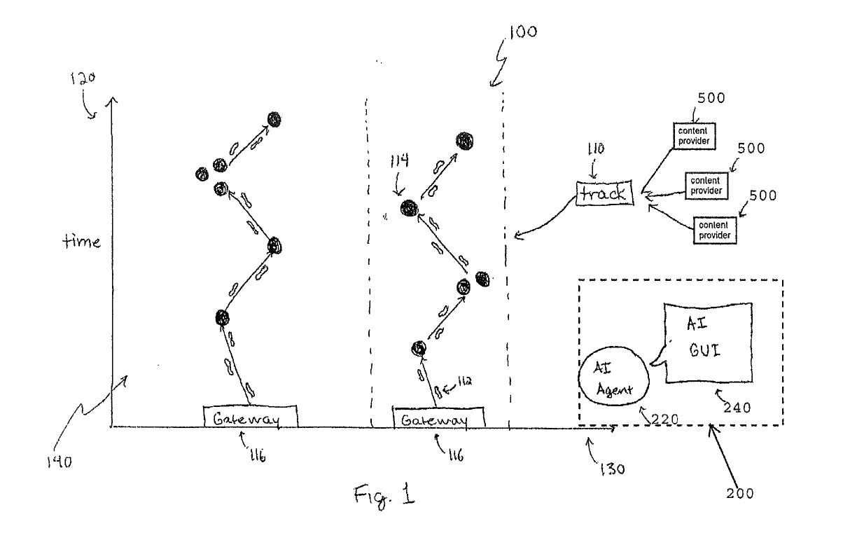

Certain illustrative embodiments of the invention will now be described with reference to the drawings. Referring to FIG. 1, a user world GUI 100 represents a map of a user's life, herein referred to as the user's “life curriculum.” The GUI 100 includes one or more project tracks 110, which together constitute a landscape 140. Each track can represent an ongoing or future aspect of the user's interest, action plan, obligation, etc. In general, each track can be considered a project for the user. For example, for users 10 who are students, a track can be one of school courses, sports teams, theater productions or other extracurricular activities. For adult users, a track can be one of hobbies, fitness regimens, career development or work responsibilities, buying a house, renovating a house, selling a car, etc. The user world 100 may also include social tracks for family and friends, such as a wedding track or a fiftieth anniversary track. Tracks 110 preferably can have a starting date and may either have a distinct end date or be ongoing. Tracks 110 can further include discrete steps 112, which can be represented by a stone, brick or dotted line that corresponds to a discrete unit of time.

Each track in the user word GUI 100 has a time dimension and includes a plurality of objects 114 positioned along the time dimension. An object 114 can be regarded as a component of a track, and may be a learning process, a task, an event, a specific project, a specific obligation, a milestone, or an assignment belonging to the track. Objects 114 may be represented by icons that reflect the nature or characteristics of the objects, and can be further animated to reflect a degree of difficulty or urgency, or to reflect that a task 110 is past due (for example, an object 115 may be an exclamation point icon that is glowing, pulsating, smoking or on fire in the case of an ongoing emergency).

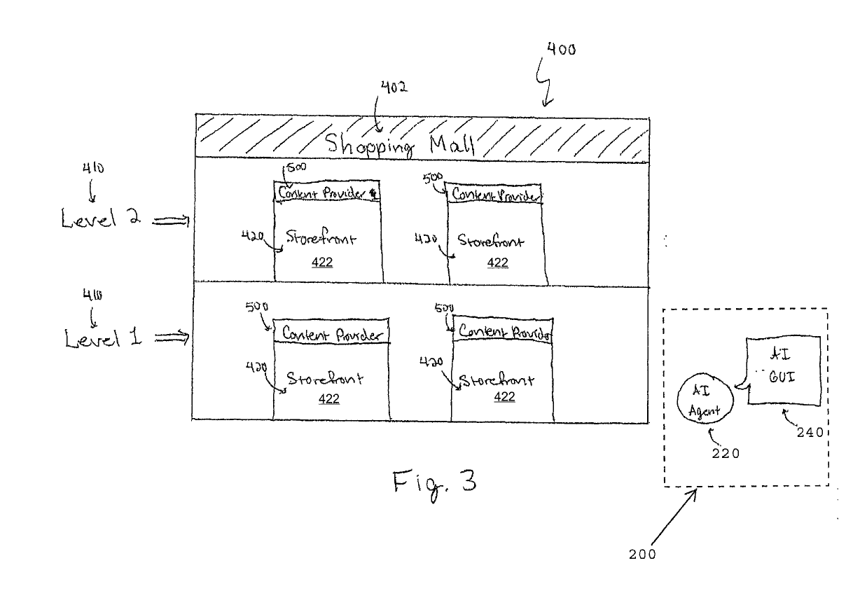

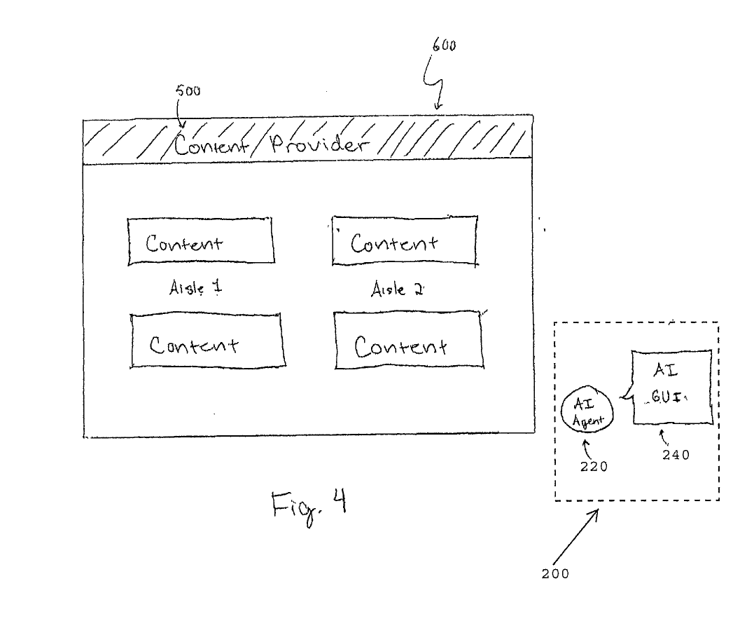

In certain embodiments, additional GUIs represent content worlds 400 (see FIG. 3) and content provider worlds 600 (see FIG. 4) are provided, and users 10 can navigate through and between their user world 100, content worlds 400 and content provider worlds 600. The content worlds 400 can include the various content items relevant to the one or more tracks (or the objects thereof) of the user worlds. The content items can include a variety of digital content, i.e., generally anything published that can be accessed electronically, such as websites, ebooks, stream videos or audios, online games, and social media.

In certain embodiments, and as illustrated in FIG. 3, content worlds 400 can be represented as a virtual shopping mall 402, which hosts a plurality of the stores, each “rented” or otherwise occupied by a content provider 500. Shopping mall 402 may be further divided into different levels 410, each hosting content or products falling in a different category, e.g., the level of sophistication of the contents provided (for example, grade-levels), and users 10 can take virtual stairs, an escalator or an elevator to higher or lower levels to get more advanced or more basic information. The most relevant content from each content provider 500 can be preferably displayed on the storefront 422 of each store 420, and users 10 “browse” storefronts 422. Each store 420 can serve as a portal to a content provider world 600 (See FIG. 4). Users 10 can enter the corresponding content provider worlds 600 to purchase, rent, subscribe, or otherwise obtain content from specific content providers 500. Alternative embodiments include content worlds 400 and content provider worlds 600 represented by different architectural and/or thematic frameworks. Content worlds 400 may have their own interconnections to allow the user 10 to explore related or similar subjects. In certain embodiments, an AI Agent 220 may suggest traveling through the links to explore additional content.

In certain embodiments, a user interaction component 200 is provided in connection with each of the user world 100, content worlds 400 and content provider worlds 600. The user interaction component 200 is configured to help users 10 navigate through and between their user world 100, content worlds 400 and content provider worlds 600, for example, by providing reminders, coaching and helping organize tasks based on predetermined schedules, due date, priority, or other preset or user-defined conditions or criteria of these tasks.

The user interaction component 200 can include an AI agent 220 and an AI GUI 240. The AI agent 220 can be a digital avatar defined or selected by the user, e.g., an avatar having similar characteristics as the user 10 (for example, the avatar may be of the same age as the user, and the user and the avatar may age in tandem), or any other images, icons, symbols, or other graphical elements selected by the user as desired. The AI GUI 240 can be designed to operate under a conversation (or dialogue) format, i.e., the user interacts with the AI GUI 240 by a sequential round of questions (posed by the GUI 240) and corresponding answers (made by the user). Based on the user's input, further information, such as further options, is then displayed to the user. For example, based on the time the user activates or launches the user world GUI 100 or upon receiving user input regarding performance of any tasks on any of the tracks, the GUI 240 can present options to the user (e.g., for an assignment in a track of a student, the options can include reviewing course materials, performing warm-up exercises, playing course-related games, etc.). Depending on the user's selection from the options, the AI GUI can present further options for the user to respond or select, or direct the user to an environment such that the action in the selected option can be performed (such as taking an online test or viewing an online video). In some embodiments, the content of these options can be provided by one or more content providers, and in such cases, in response to the user's selection of an option, the AI GUI can direct the user to “consume” the content (e.g., watching a video provided by the content provider or performing an interactive quiz provided by the content provider, etc.) and/or browse (and/or consume) other similar/related contents offered by the content providers, as described above in connection with FIG. 3.

In some embodiments, the AI GUI 240 has a generally consistent theme throughout different GUIs of the application but can include different text/options depending on the context (e.g., depending on which worlds the user is currently navigating, which tasks are being performed by the user, etc.). For example, the AI GUI 240 can include a dialog callout box containing text that depends on the user's previous selected options, impending tasks, etc. and further include menus, buttons, and other commonly used interface control elements for the user to select and respond to. The AI GUI 240 can use various modes to interact with the user, e.g., via conventional click and select (by a pointing device, e.g., a mouse, or by a finger touch for a touchscreen-enabled device), via voice prompt and recognition, or the like. The user interaction component can be configured such that the user perceives that it is the AI agent 220, e.g., the screen avatar or figure, that is interacting with the user to navigate the content worlds 400 and the content provider worlds 600 by offering recommendations or tips, and guiding the user to other relevant information or more advanced information depending on the user's interests. For example, through the AI GUI 240, a user can also be taken from any track 110 or object 114 to content worlds 400 and content provider worlds 600 where the user can access information related to a specific point or object on the track 110.

In certain embodiments, these various GUIs can be incorporated in an application running on a user computing device, which can be a desktop or laptop computer, a handheld device (such as a smart phone, a tablet, etc.) or on a custom device designed for the application. Depending on the operating system (e.g., Windows, iOS, Android, etc.) of the computing devices and/or graphics specific hardware/software available on such devices, the GUIs can be created by any suitable technology or programming language, e.g., Java, C++, C#, PHP, Python, Ruby, Visual Basic, Javascript, etc., as appreciated by one of ordinary skill in the art. Also, as appreciated by those skilled in the art, the user computing device can include one or more computer processors, one or more computer readable media (such as memory devices RAM and ROM) associated with the processors and storing the application for generating the GUIs and other functionalities of the application for managing life curriculum tracks of the users. The user computing devices can also include one or more permanent storage devices (a flash memory, a hard drive, a solid state drive, an optical drive, etc.), a display for displaying the GUIs, and other input/output hardware such as pointing devices (e.g., a mouse, a digital pen, a capacitive pen, etc.), a keyboard, a joystick, a touchscreen, a wireless receiver, etc., as commonly known in the art.

While the GUIs can be generated directly by an software application stored in a memory of the user computing device, they can also be part of a web page or web pages retrieved from a web-based application hosted by a remote server or a cloud computing system. In such a case, the GUIs can be generated by the software application running on the remote server, and transmitted to the user computing device through the Internet or other wired or wireless connection (such as WiFi, LAN, WLAN, Bluetooth, etc.). For example, the user can first register with the remote server to set up an account, and then access the server application using certain account authentication credentials, such as a user login name and a password. The GUIs can be generated on-the-fly on the loading of the locally implemented software, or upon successful logging into the remote server (in the case when the software is hosted on the remote server) based on the status of tracks, time, and other user-specified parameters, as will be further described below.

One or more tracks of the user worlds 100 can be created from scratch by the user. Alternatively, the user can be provided with one or more initial tracks, which can be updated or modified by the user based on the user's needs. The user can also delete any tracks that are no longer needed.

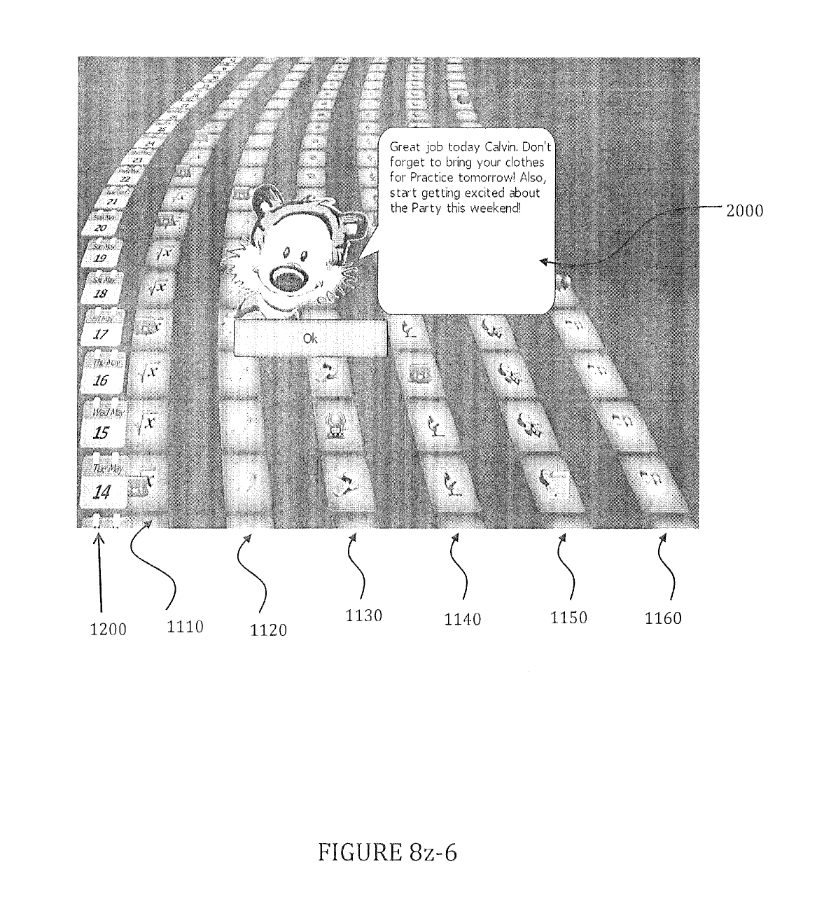

In some embodiments, the application can generate a consolidated view (e.g., the “now” view as illustrated in FIG. 9) of the objects on a selected one, or more than one project track of the user, where the objects are arranged according to priority. As an example and as described herein, the objects can represent tasks or events for the user. Thus, the consolidated view can allow the user to have a quick glance of the tasks or events on a project track or several different tracks, especially those tasks/events with high priority or urgency, and take actions accordingly. The view can include all of the tasks/events in different tracks, or a portion of the tasks/events which can be selected by the user based on one or more parameters such as priority or due date of the tasks or events, the names of the track(s), the category of the track(s), and so on. The view can have zoom and/or scroll functionality to allow the user to inspect the tasks or events in the view at different scroll positions and/or at different levels of details. Although only the text of the tasks or events are shown in FIG. 9, it is appreciated that the tasks or events can also be shown in more graphics-rich manner, such as different colors, icons, animations, etc. highlighting or accompanying the tasks/events having different priorities. The view can be generated within the user interaction component, e.g., within the callout box of the AI GUI 240, in a separate window distinct from the user world GUI 100, or as part of the user world GUI 100, or in other manners as desired. It can be generated automatically when the user first launches the application software, or upon a specific command from the user requesting the view during the use of the application software.

In some embodiments, one or more tracks of the user worlds 100 include references to external data sources. Similarly, the GUIs for the content worlds 400 and content provider worlds 600 can include references to external data sources. For example, data sources (or contents) for the tracks or track objects can be provided on one or more servers maintained or managed by one or more content providers. These servers can be networked directly with the user computing device if the software application for generating the GUIs is installed locally on the user computing device, or they can be networked with the remote server in which the software application is installed, such that the contents can be transmitted or otherwise retrieved by the application software as needed. In such embodiments, the GUIs can be dynamically generated or rendered based on their respective data sources and updated in real-time or according to a predefined schedule. For example, referring to FIG. 1, the tracks 110 in the user world 100 can be linked to the content providers 500, and each track can be updated automatically based on the updates in the source data. The user's past and current interaction with the tracks can be stored as a user history or profile, such that the application, when later loaded again, can remember the status of the user's previous session, and can provide the user an option of resuming the previous session or make certain options available to the user based on the results or status of the previous session.

A track can be initially obtained from a content provider (e.g., purchased, subscribed, or rented by or on behalf of the user, or otherwise delivered to the user), with an initial set of objects predefined. For example, for a school course, the track can be first obtained from a course vendor, and the data sources for the track (e.g., the text book used, exercises, tests, and other course related information) can be all included or referenced in the track. Some of the data sources can be fixed once the track is obtained, and certain other data sources can change or be updated during the lifetime of the track, e.g., based on availability and/or development of further materials, and/or based on the user's feedback during the use of the track. Similarly, the AI GUI 240 can be linked to the content providers 500 of each track 110, and the AI agent 220 can keep the user apprised of relevant information in real time or according to a predetermined update schedule.

In some embodiments, a track can be customized by a second user different than the end user (e.g., a student). For example, a teacher can create one or more objects such as homework assignments, tests, etc. in addition to those already available in the track, or the teacher can modify (including deleting) the objects included in the track as obtained or those previously created by the teacher. The student user can also create additional objects, and modify the objects on the track (including setting priority, due date, or other parameters for the objects). When multiple users are given access to a track, different privileges can be assigned to different users such that proper rules can be maintained (depending on the application and context) and confidentiality of each user is protected. For example, for the above example, the objects created or modified by the teacher can be protected against any modification by the student, whereas the access history and activity of the student using the track can be shielded from the teacher's eyes.

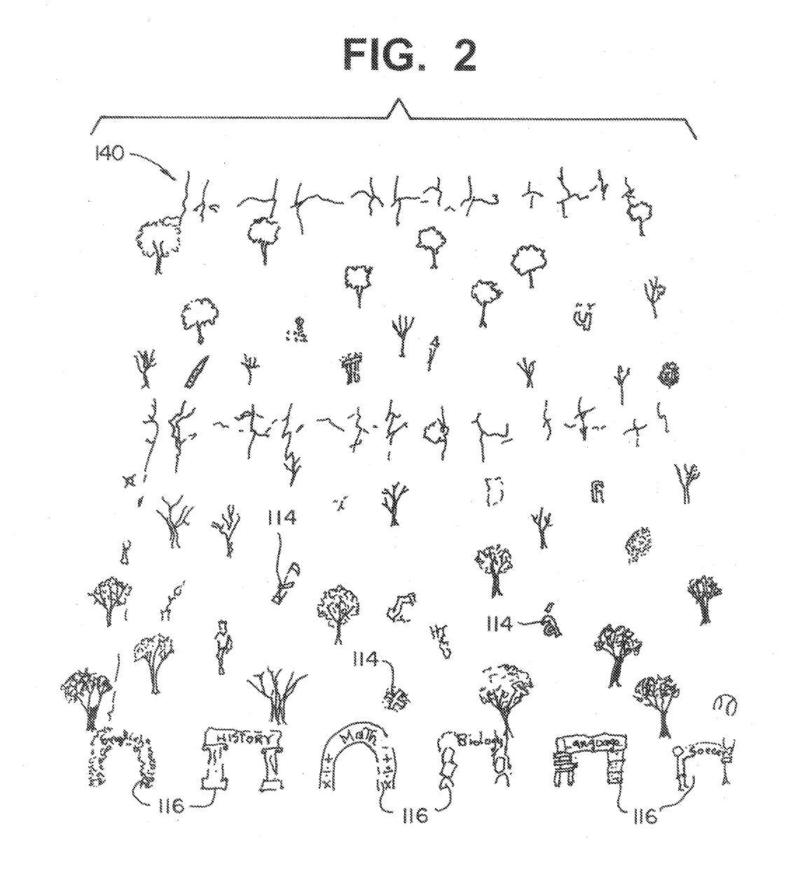

Referring to FIG. 2, in certain embodiments, the user world 100 can include a landscape 140 with multiple life tracks 110. A user 10 can enter tracks 110 through gateways 116, which are labeled along the horizontal axis 130 of the landscape 140. The vertical axis 120 can represent the time dimension. It is appreciated that the time dimension can also be presented in a different manner, such as on a horizontal axis, in 3D perspective, on a curve, etc. The time dimension can be labeled by any desirable time units, such as calendar days. The landscape 140 preferably extends along the vertical axis 120 to cover a future time period for the user 10. User 10 can zoom in and out of the landscape 140 to see shorter or longer periods of time, with the level of detail adjusted accordingly, either automatically or manually. In one embodiment, the bottom of the landscape 140 represents the present time and the top of the landscape 140 represents the near, or distant, future. The landscape 140, and associated tracks 110, can be rendered based on the available tracks subscribed (or purchased, rented, subscribed, or otherwise obtained) by the user 10. As time passes, additional portions of landscape 140 can be generated at the end of the time horizon. The user can also customize the tracks, e.g., by adding and deleting objects from the tracks to suit his or her own needs.

In some embodiments, and as illustrated in FIG. 2, tracks 110 in the landscape 140 can simulate a series of meandering parallel pathways with the topography, flora and fauna of the landscape 140 reflecting the nature of the tracks 110 (for example, a math course track may go through a landscape of three dimensional math objects such as numbers and arithmetic symbols; a biology track may go through a landscape of cells, skeletons and DNA; a history track may go through a landscape of cannons, crowns and maps; and a soccer team track may go through a landscape of balls, fields, referees, whistles and cleats). The landscape 140 may have a background for all the tracks, reflecting the current season (for example, the landscape would get greener during summer, show foliage in the fall, snow in the winter and flowers in the spring). Alternatively, the objects in each track can have a design pattern (such as color, background color, shape, etc.) to reflect the nature or characteristics of the track and/or the specific objects. Challenging times such as exam week or the end of the fiscal period may have rocky patches, stormy weather or river rapids that need to be bridged. Conversely, smooth times like vacations and long weekends may be shown as sunny and placid. The landscape 140 may also be age appropriate (for example, a child's landscape may look more game-like, while an adult's would appear more realistic). As the user 10 ages, or as the user 10 scrolls through time, the landscape can change to reflect his or her age, or anticipated age. As users 10 add additional tracks (either by creating the track on his/her own, or obtaining it from a content provider, e.g., by purchasing and downloading the tracks), each additional track 110 can be seamlessly integrated into the landscape 140.

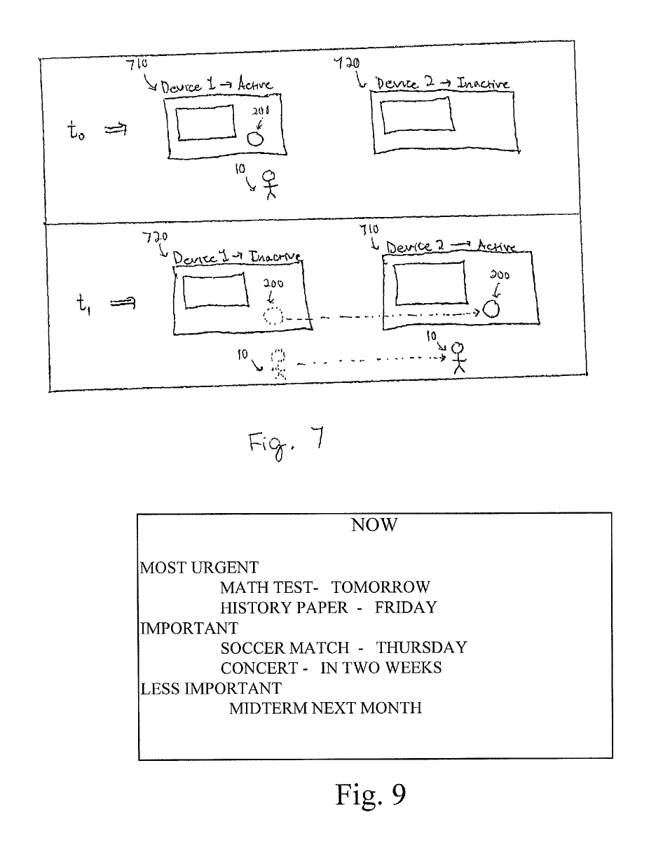

In certain embodiments, and as illustrated in FIG. 7, if the user 10 accesses any of the GUIs on multiple devices, the AI agent 220 can be configured to “follow” the user 10 by fading away from the inactive devices 720 and appearing on the active device 710. For example, if the user is accessing any of the GUIs described herein on a smart phone and a PC, and the user subsequently accesses any of the GUIs on a tablet, the AI agent fades from the smart phone and PC, and appears on the tablet). In this way, the AI agent can be viewed as a companion who moves with the user 10 rather than a static component of each GUI.

In certain embodiments, and referring to FIG. 6 for illustration, user 10 can access appropriate information through reference to a curated, indexed registry 700 of content. The registry 700 can be configured to include multi-attribute indexing and search capability to provide information based on the user's input inquiry. In certain embodiments, the AI agent 220 can provide the user with guidance through appropriate AI GUI 240, e.g., in a search format or a dialog format, to appropriate information to the registry 700.

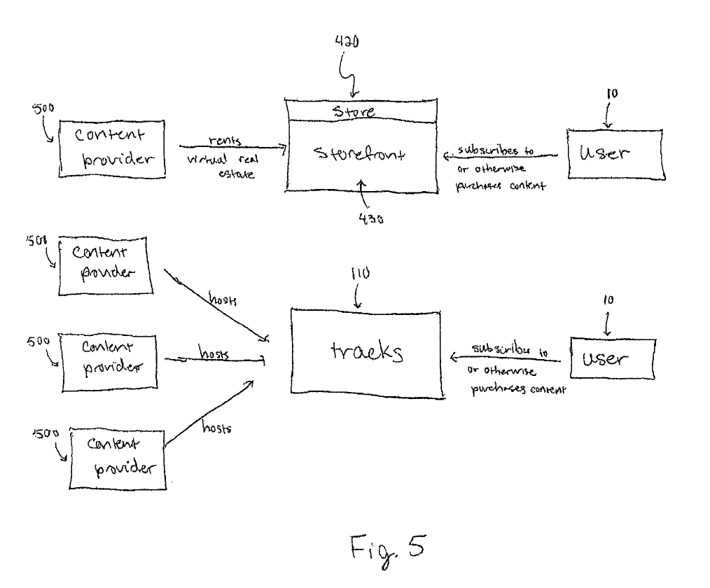

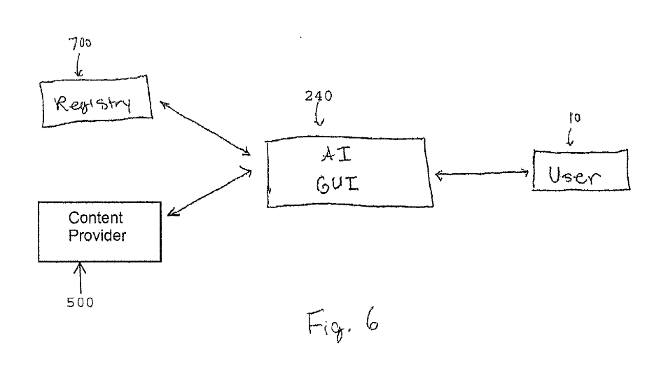

In another aspect, the invention provides a revenue generating method based on the platform provided. For example, as shown in FIG. 5, content providers 500 may pay to “rent” virtual real estate in the content worlds 400 (which can be operated by a different entity), with premiums for better placements and enhanced displays. The content world operator can also sell subscriptions to users 10, and can further provide payment services (and charge corresponding fees or permissions) for purchases of contents made by the users 10 in the content worlds.

Referring FIGS. 8a-8z and 8z-1 to 8z-6, an exemplary computer-implemented process according to embodiments of the invention is illustrated on a display of a user computing device. The process uses a user interaction component which includes an AI agent which takes the form of a cartoon character Hobbes to help a hypothetical user named Calvin, a 7th grade student, to navigate around and perform various tasks on the plurality of Calvin's life curriculum tracks. As will be appreciated by a person of ordinary skill in the art and in view of the description herein, the logic flow and the presentation of various graphical elements in these figures can be programmed in a software application resident on the computing device or hosted in a remote server then transmitted to the user computing device via the Internet or other networks.

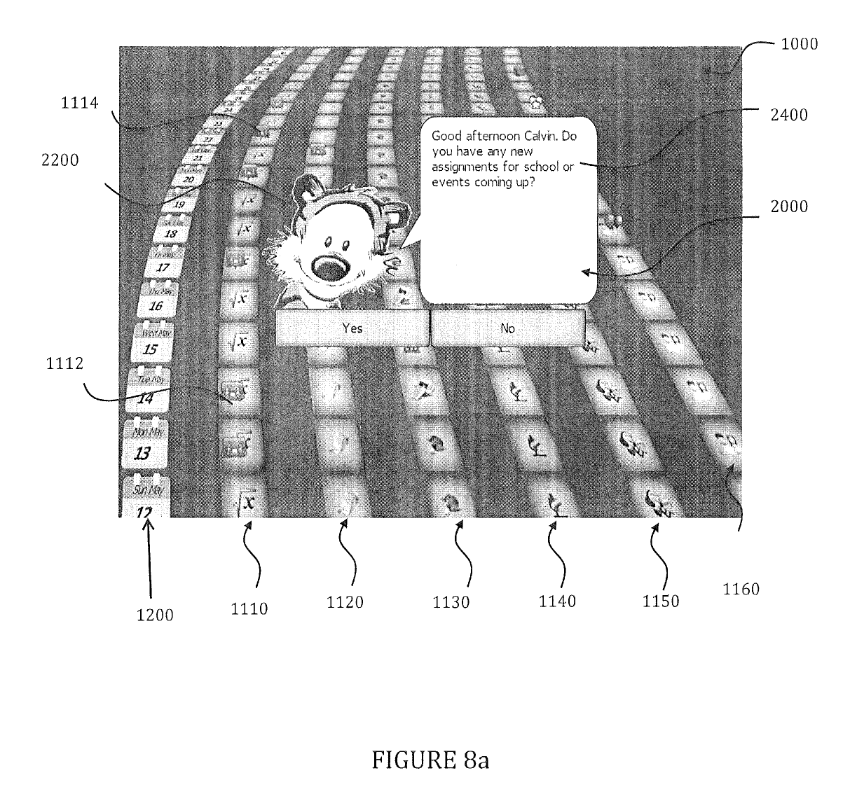

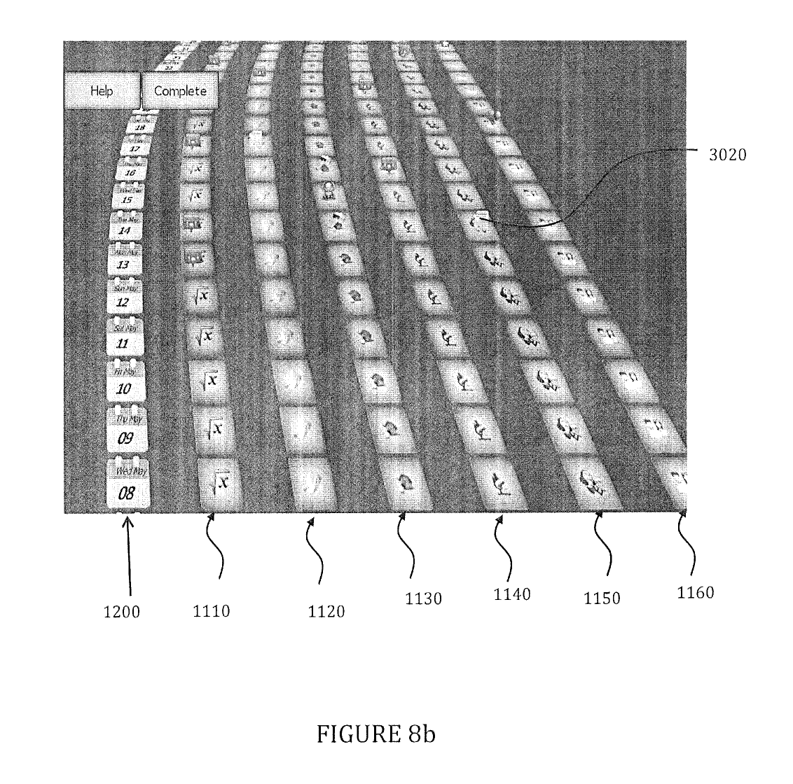

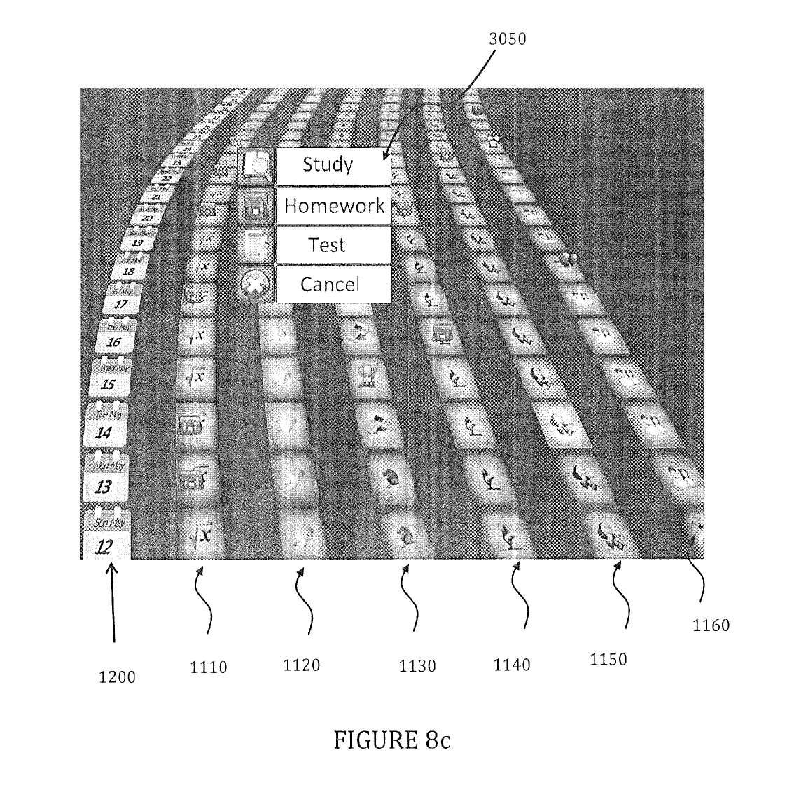

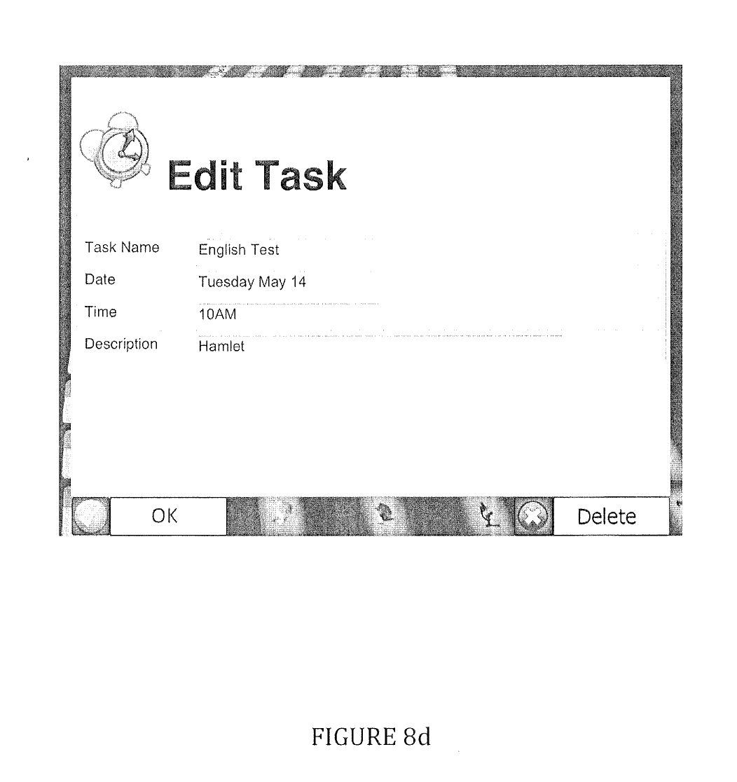

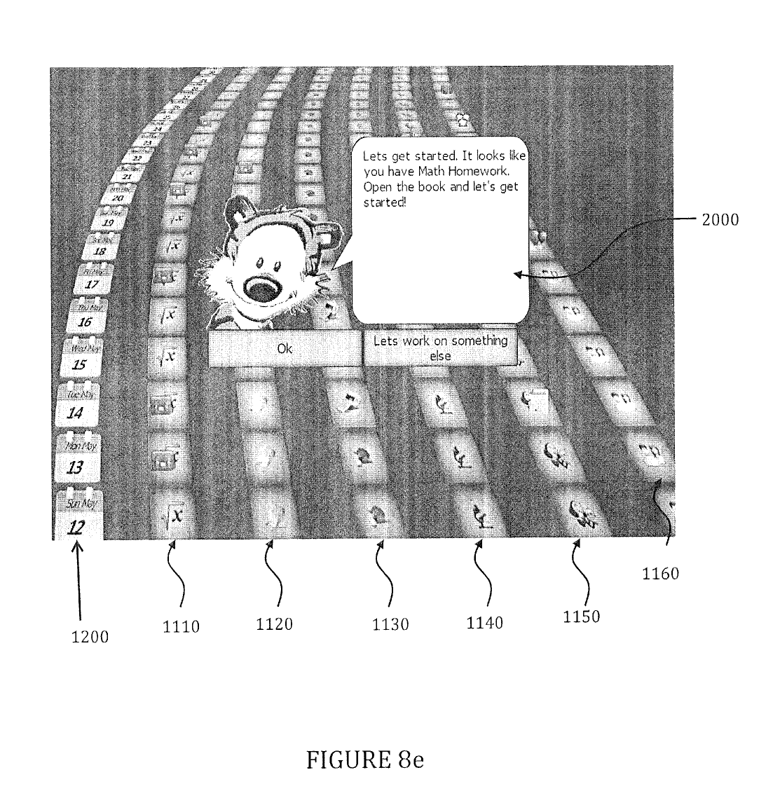

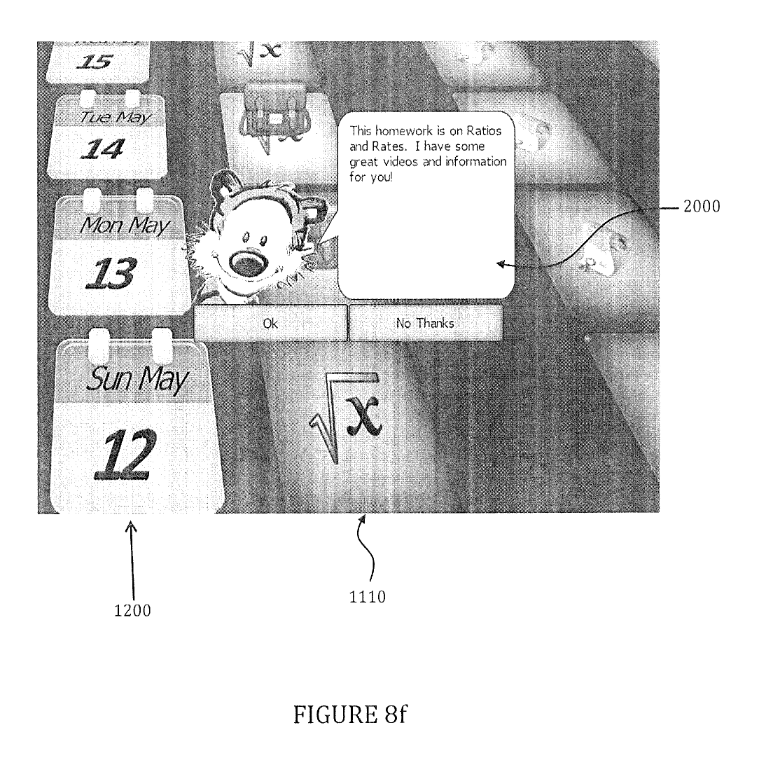

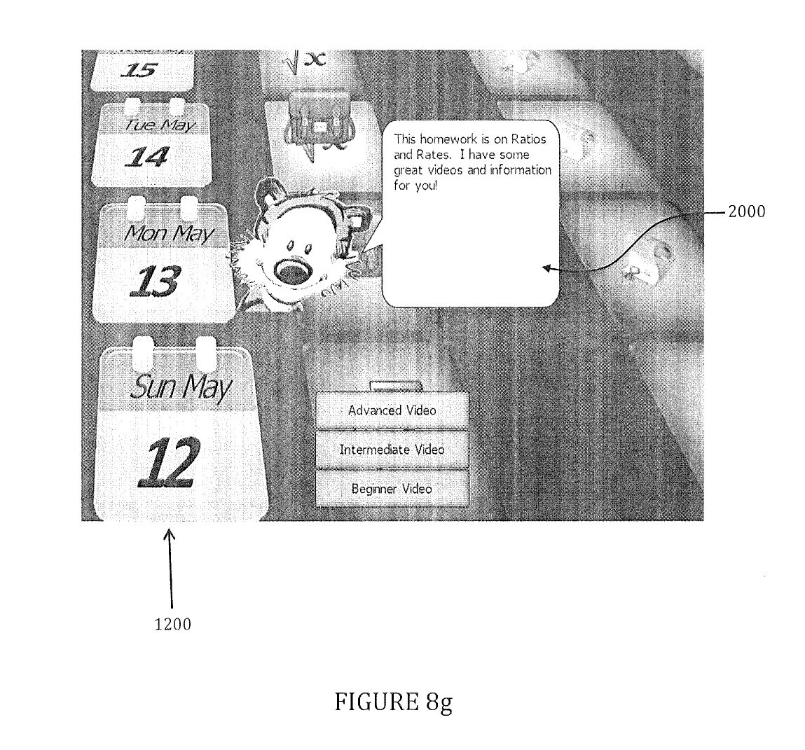

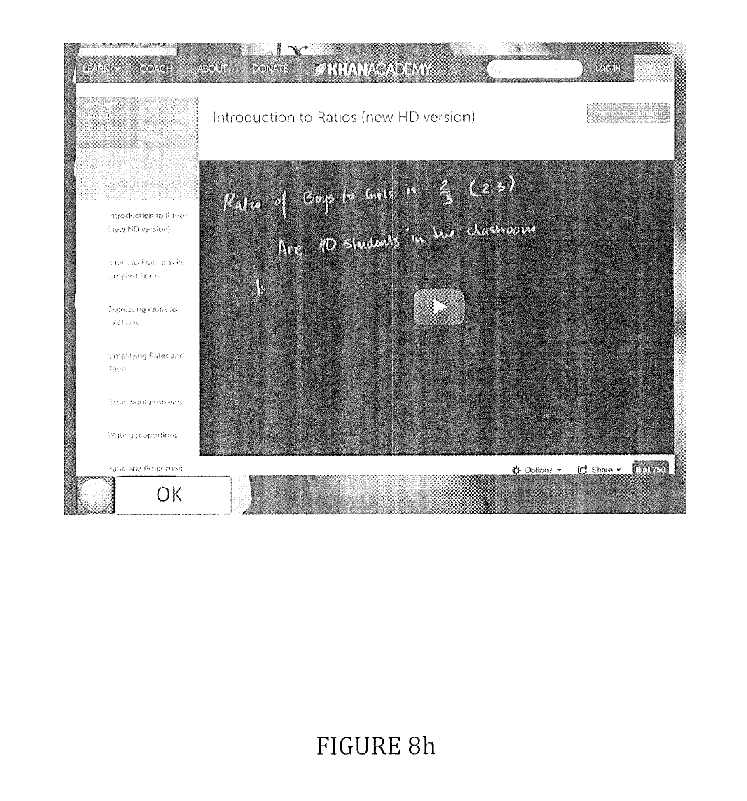

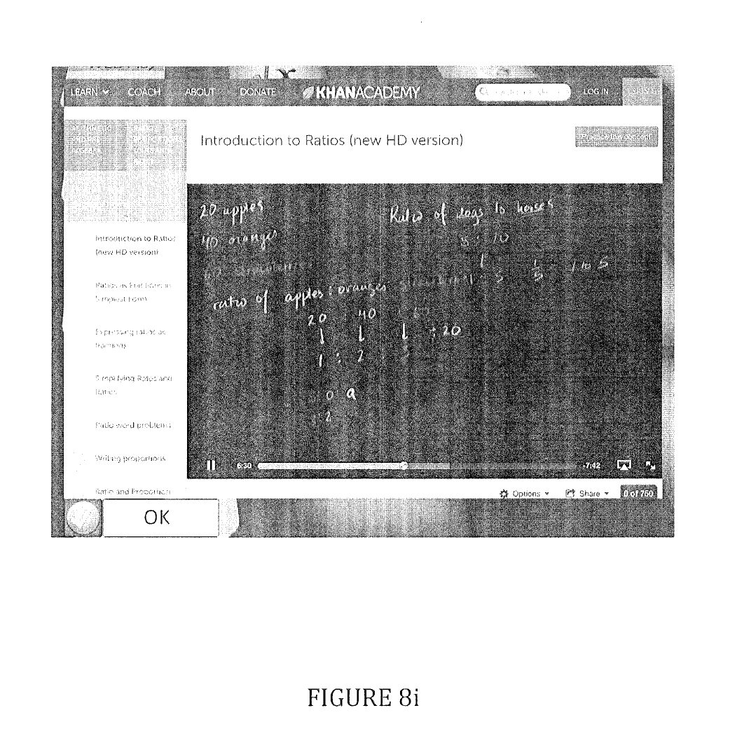

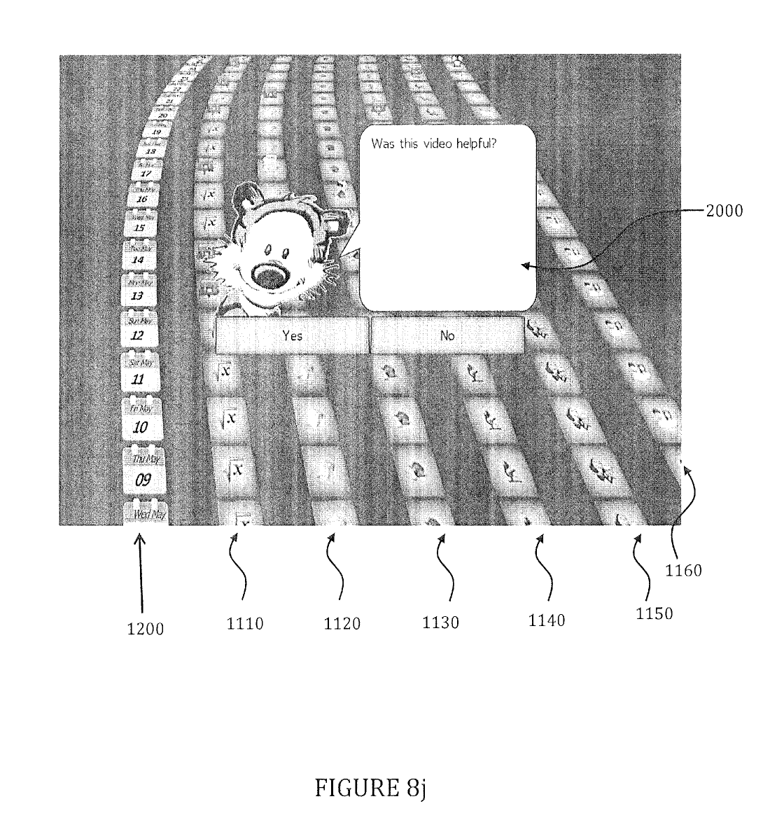

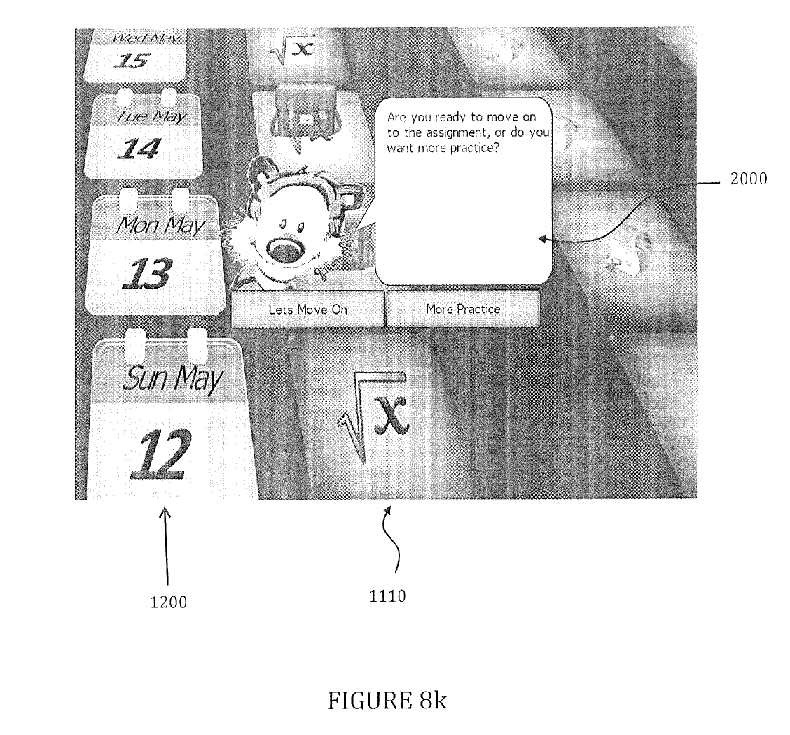

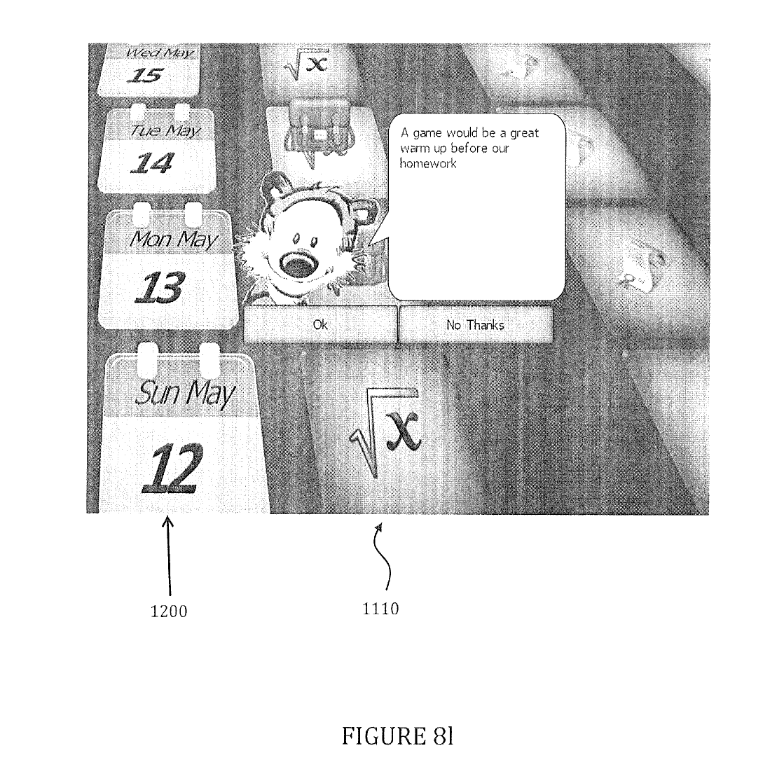

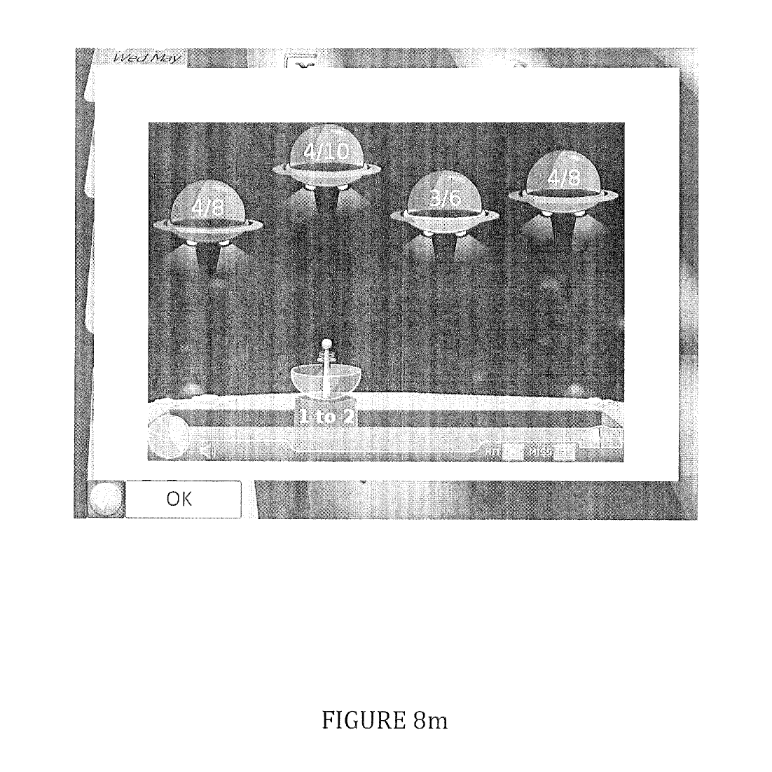

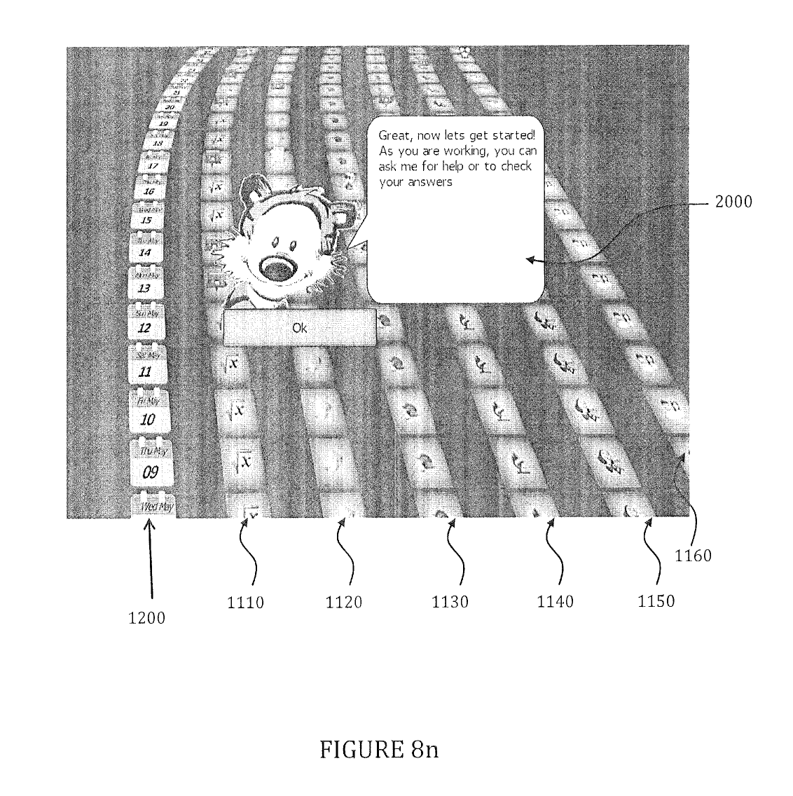

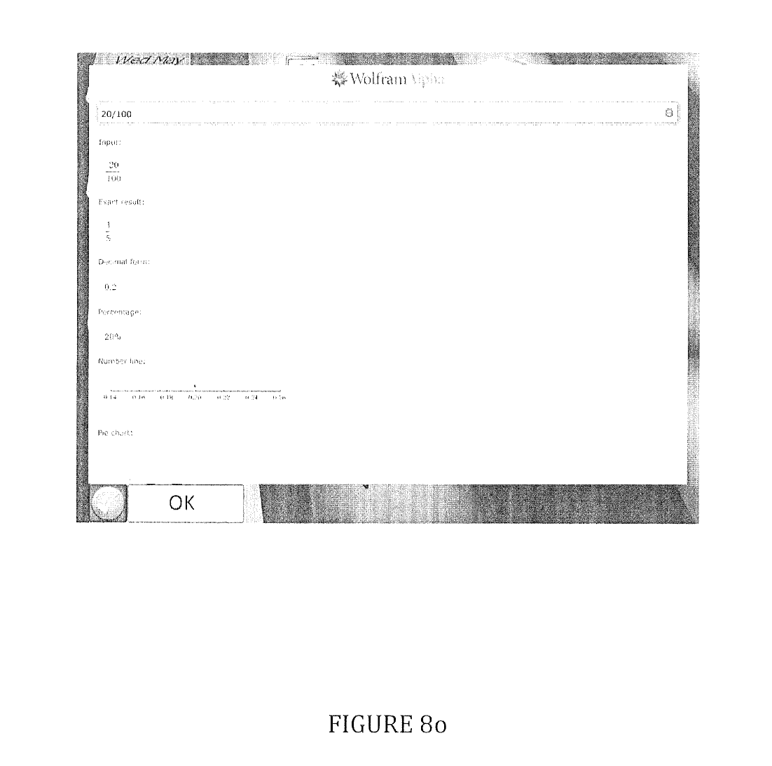

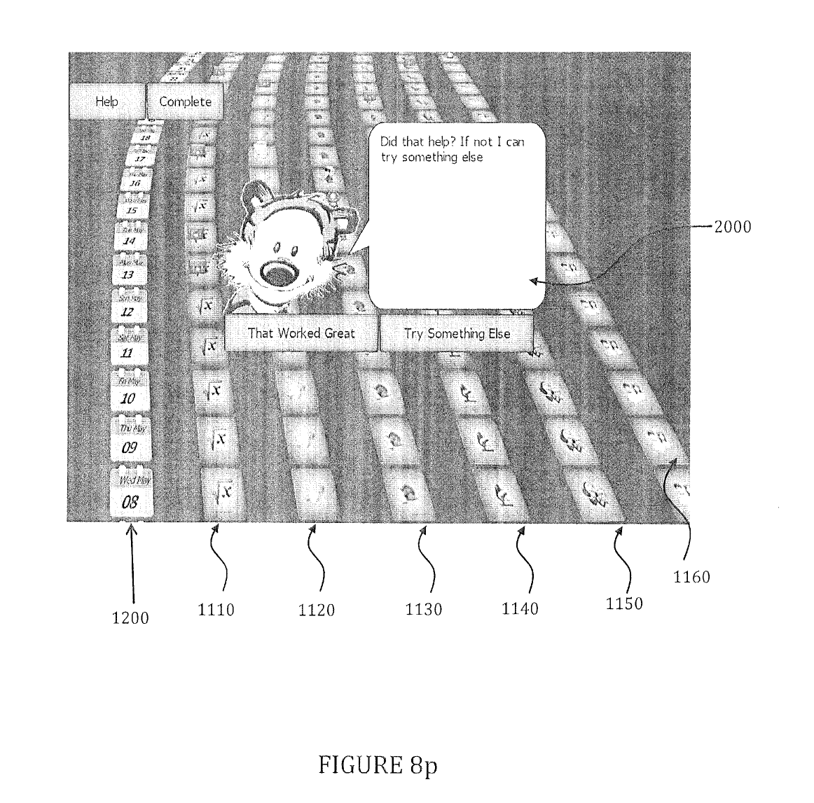

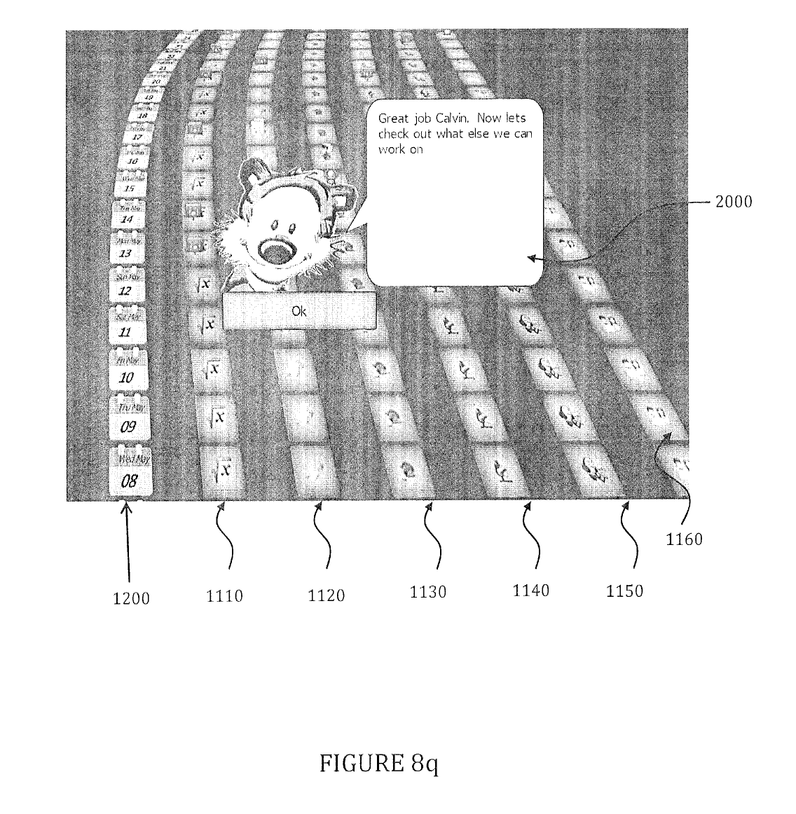

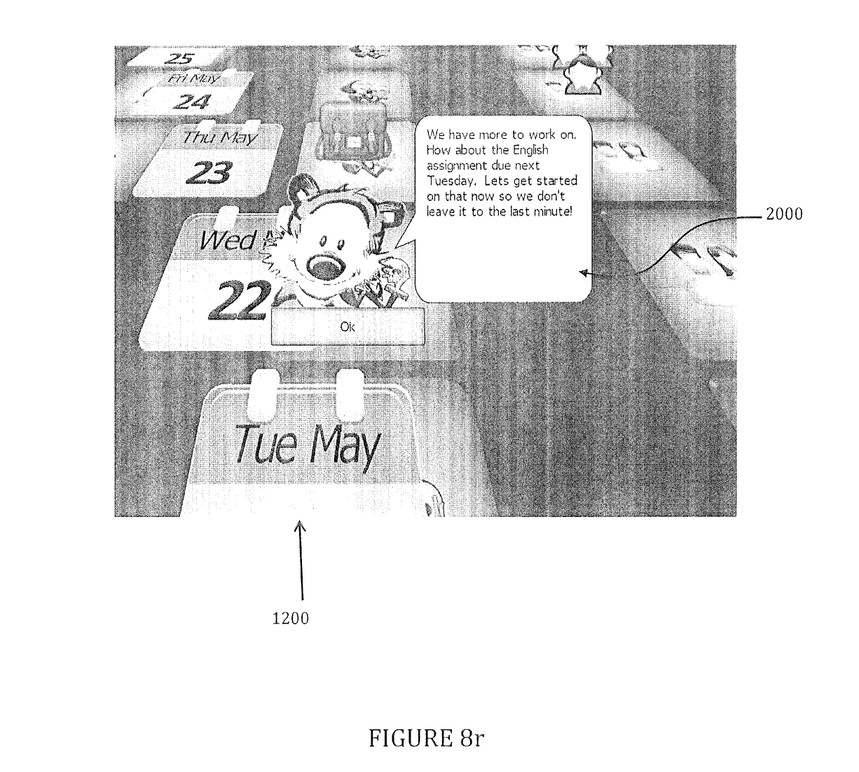

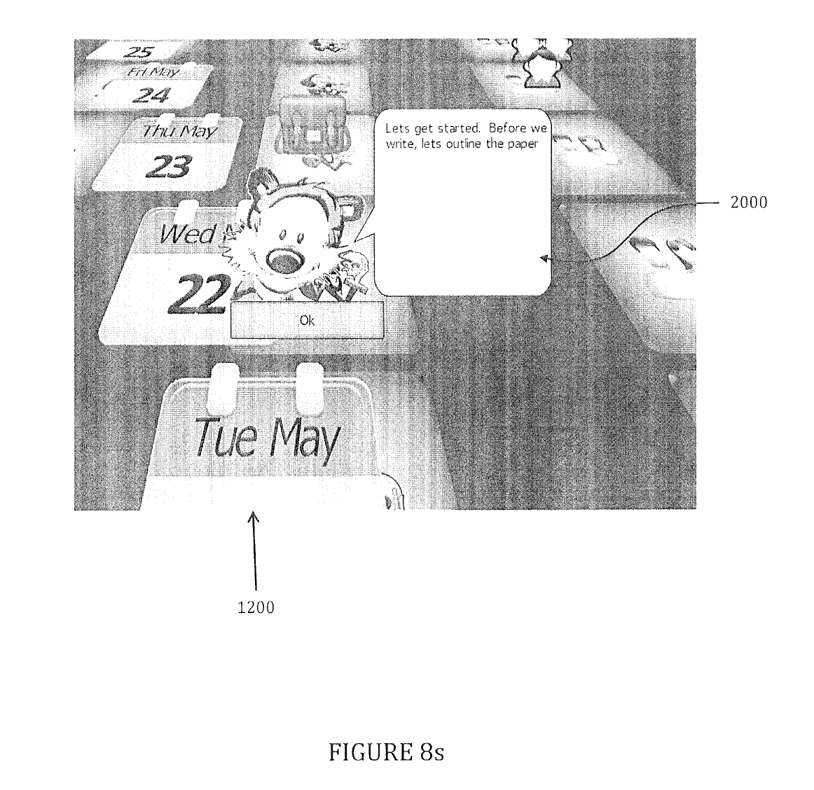

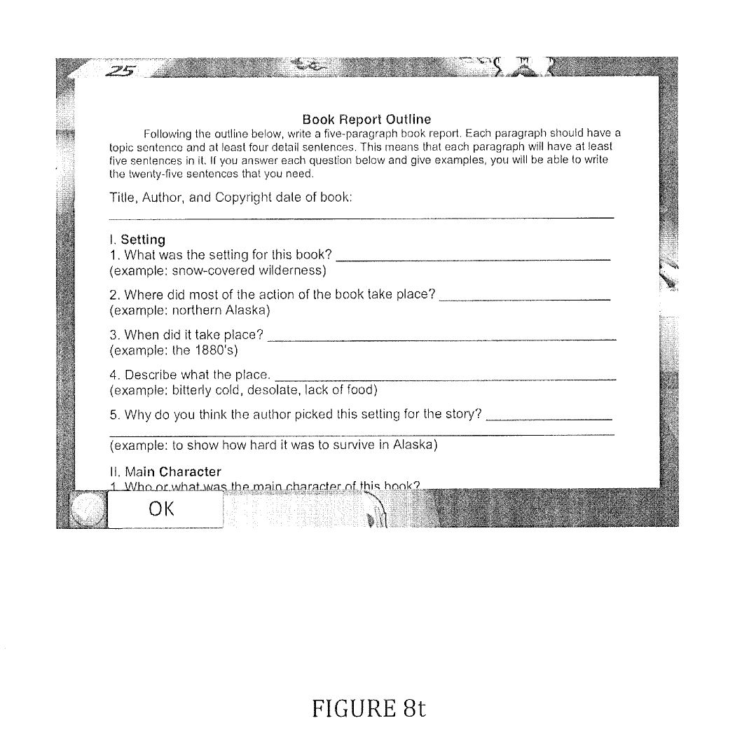

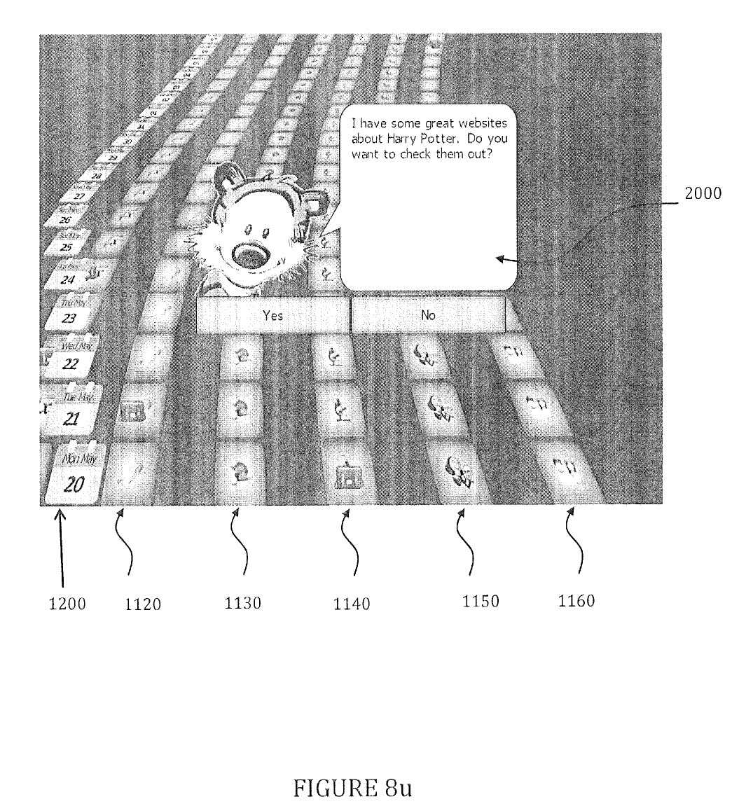

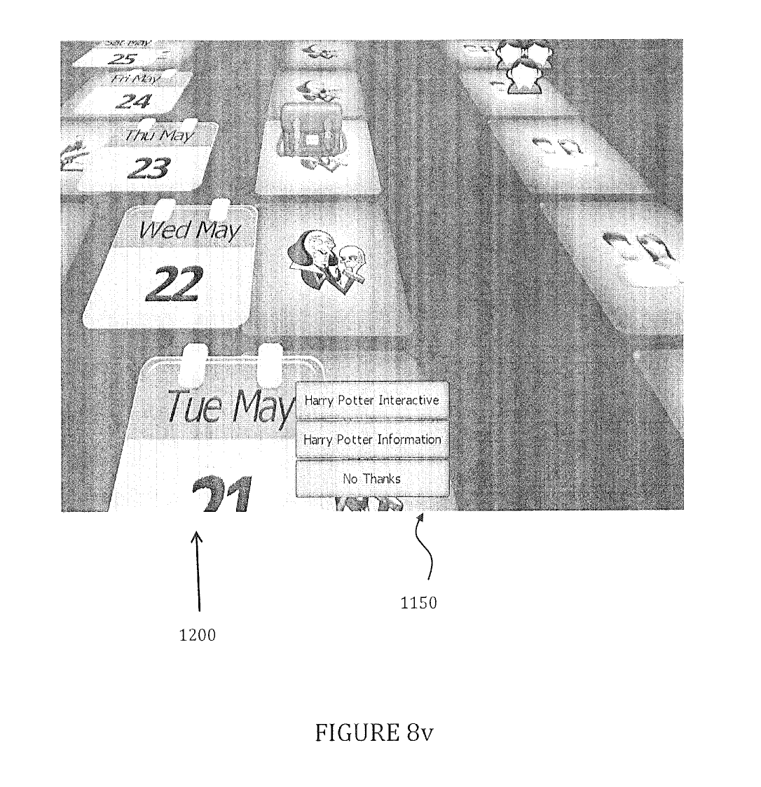

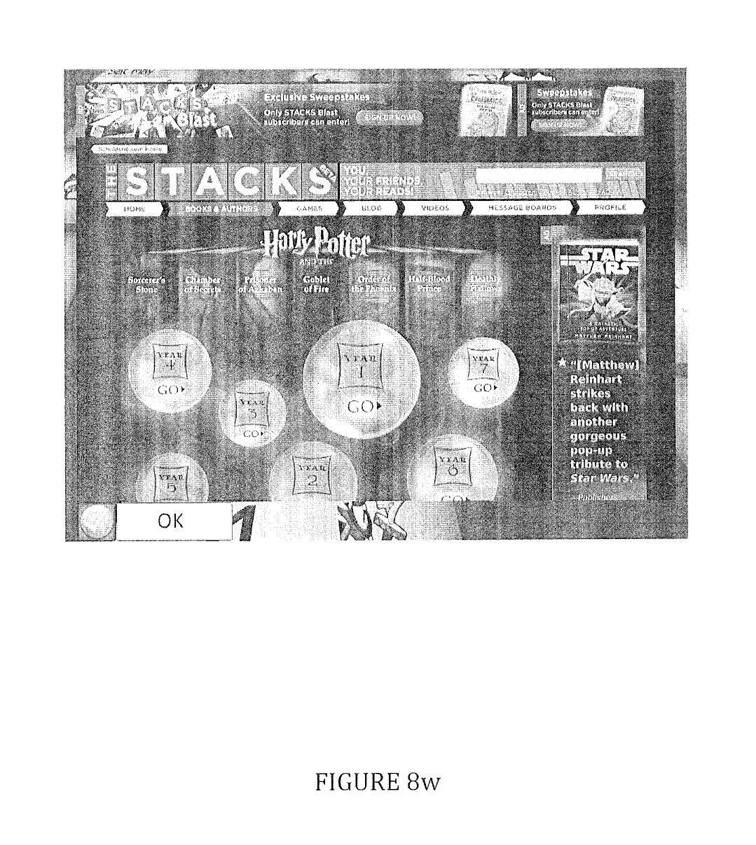

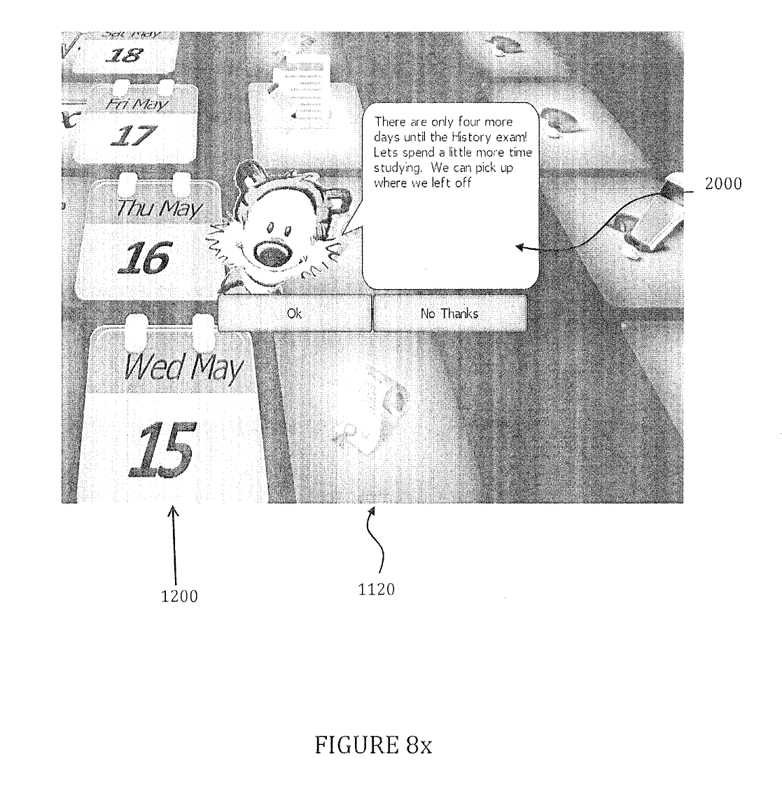

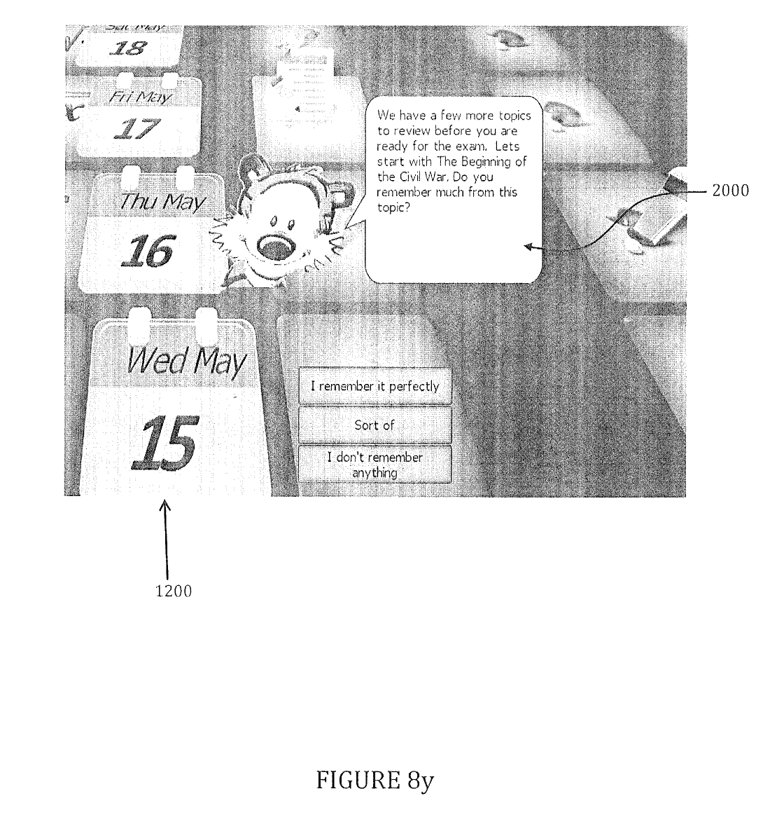

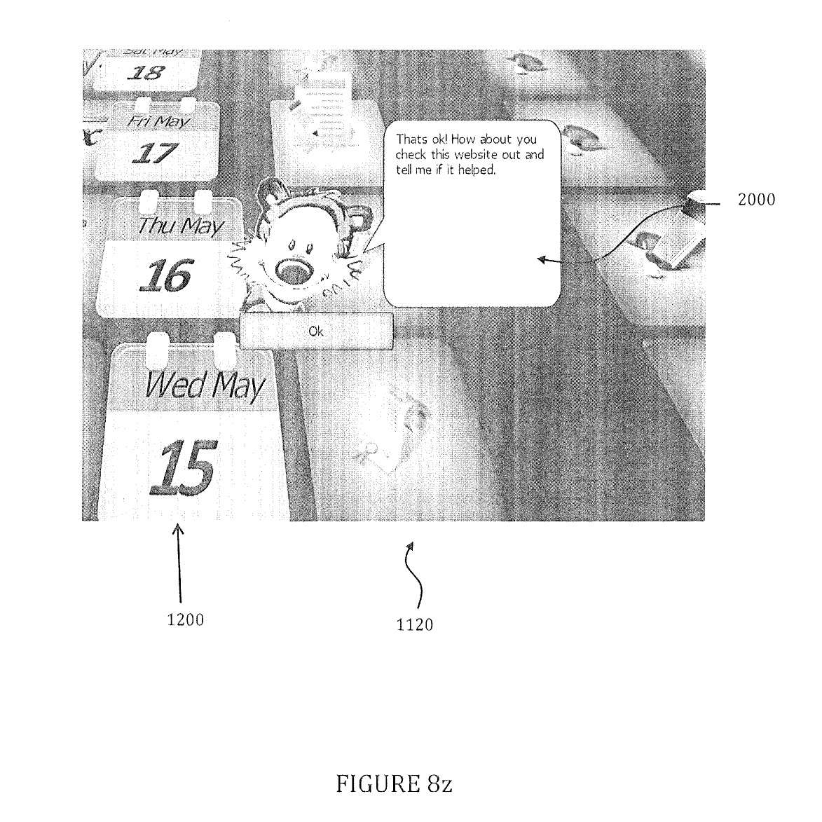

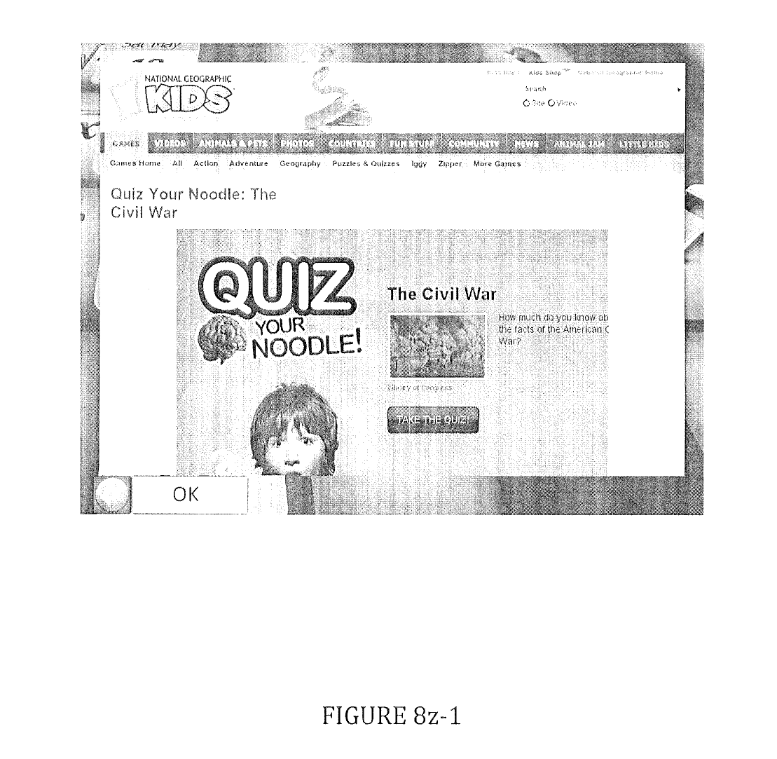

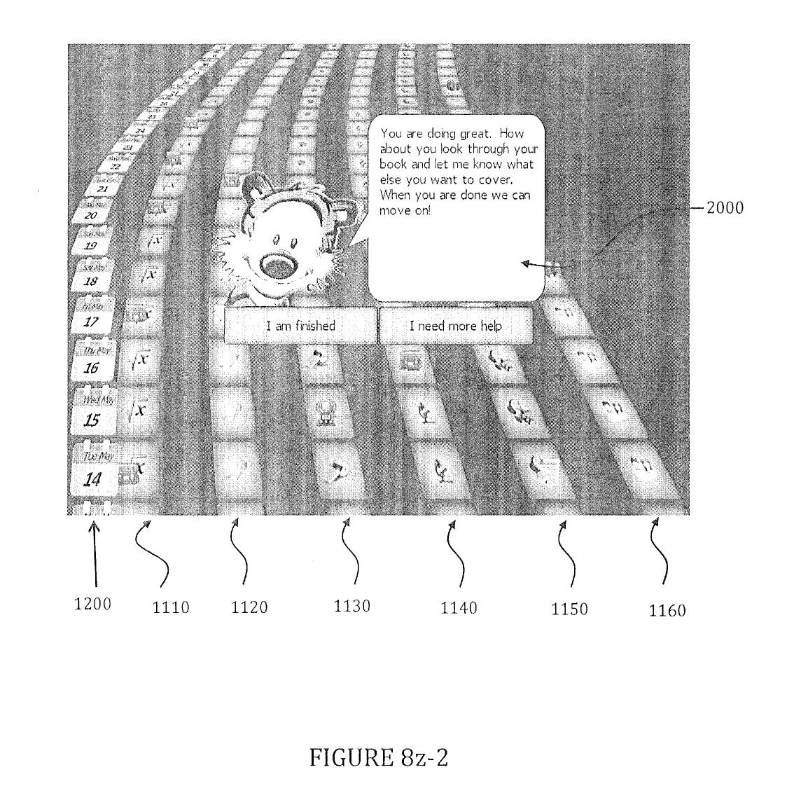

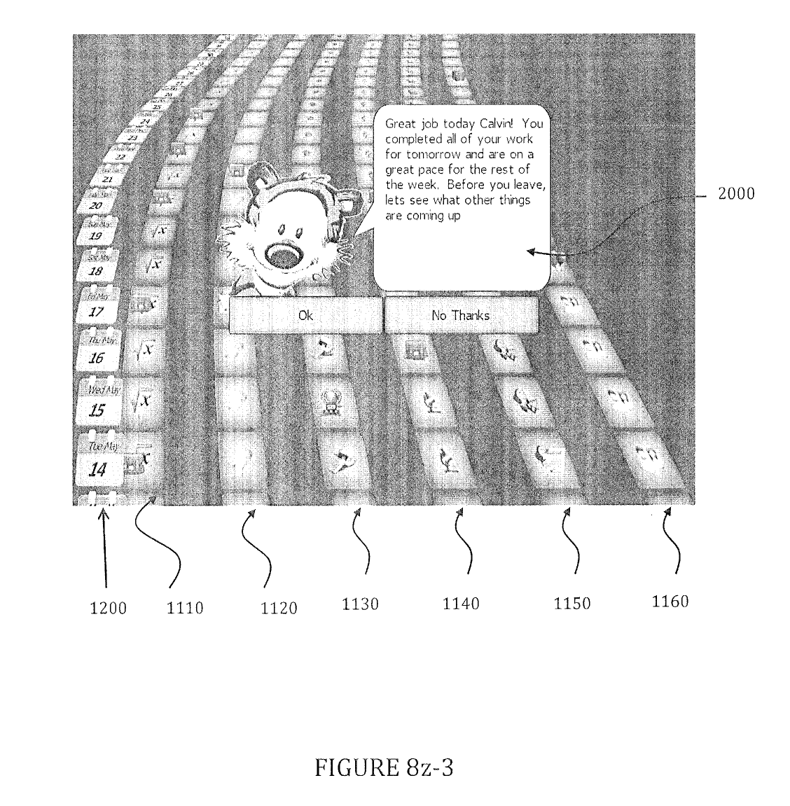

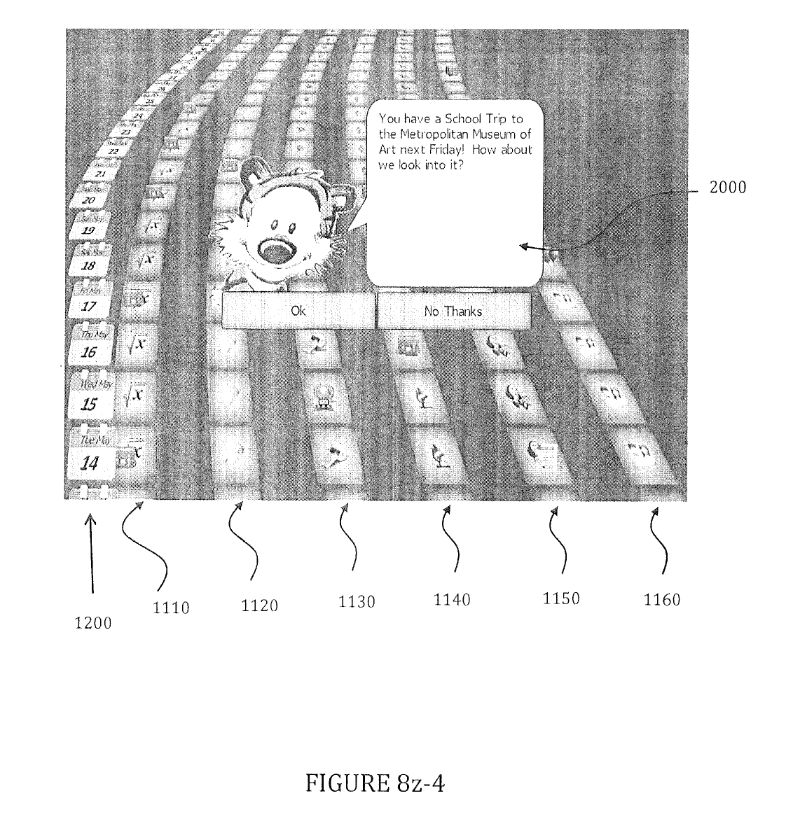

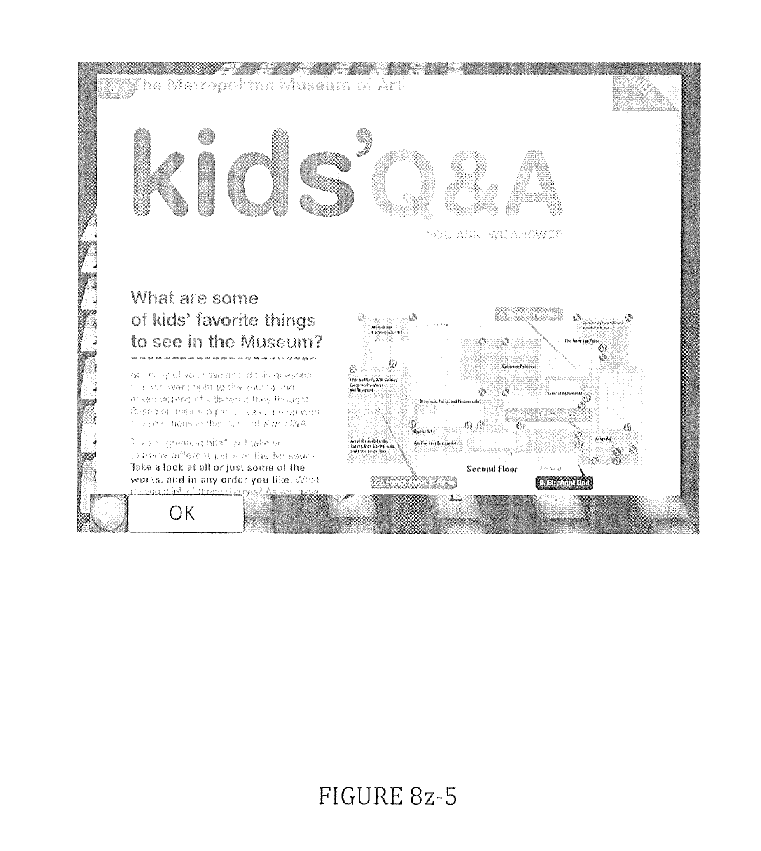

As shown in FIG. 8a, which can be an introductory page when the software is first loaded on a user computing device, e.g., a home computer of Calvin when Calvin starts a homework session, a user world GUI 1000 for Calvin includes a time dimension 1200 represented by a series of calendar day icons arranged from bottom to top in a perspective view, and a plurality of life tracks 1110, 1120, 1130, 1140, 1150, and 1160 running along the time dimension, each track representing a project for Calvin for a given period of time, e.g., a course for a given semester. For example, track 1110 is a track for a math course, and the track is represented by a series of tiles each having a background including an expression of “square root of x.” Further, the track 1110 can include a plurality of objects, such as 1112 and 1114, with an icon of a briefcase superimposed on the background, which can represent specific tasks (e.g., a homework assignment) required or planned on the track 1110. Placed in front of the tracks is a user interaction component 2000, including an AI agent 2200 (shaped as a Hobbes figure or avatar) and an AI GUI 2400 which further includes a callout dialog box containing a question mimicking an utterance by Hobbes (“Do you have any new assignments for school or events coming up?”) and associated “yes” and “no” buttons for Calvin to select. It is appreciated that the user interaction component 2000 can be placed in different locations relative to the tracks, e.g., on the side of the tracks so as to not block any portion of the tracks from view.

Upon Calvin's selection of “Yes” on FIG. 8a, the user interaction component disappears from the screen (see FIG. 8b), and Calvin is allowed to create a new object (or event) or modify a previous event by selecting a tile of one of the tracks 1100-1160 (if Calvin wants to add/edit an event not shown in the visible view, he can scroll through the screen as needed).

Upon Calvin's selection of one tile 3020 on May 14 on the track 1150 representing an English course (on FIG. 8b), an option menu 3050 can be generated (FIG. 8c), asking Calvin which type of event or task that Calvin wants to create or modify, the options including “Study,” “Homework,” and “Test”. If Calvin selects “Test,” a separate pop-up window (FIG. 8d) can appear with appropriate fields for Calvin to fill in the name, date, time, and description of the test. Calvin can then click “OK” (on FIG. 8d) to confirm the addition/modification of the test.

Next, the application determines that there is upcoming Math homework that Calvin may need to complete (based on urgency, time involved, Calvin's preferences, etc.). Thus, as shown in FIG. 8e, the user interaction component 2000 reappears, and the text in the callout box of the AI GUI includes a suggestion for Calvin to perform such a task. The AI GUI includes a button “Ok” for accepting this suggestion, and a button “Lets work on something else” to allow Calvin to choose something else to work on.

Upon confirmation by Calvin (e.g., by clicking the “Ok” button shown on FIG. 8e), the application zooms in the calendar to more clearly show the topic of the assignment (relating to “Ratios and Rates” as shown in FIG. 80 and offers some content (e.g., videos) that may be helpful for Calvin relating to the assignment.

If Calvin selects “Ok” shown on FIG. 8f, the application can lead Calvin to a screen shown in FIG. 8g, where Calvin is given three options to select from: Advanced Video, Intermediate Video, and Beginner Video. If Calvin selects one of the options, a corresponding video can be shown in a separate window (see FIGS. 8h and 8i). The video be natively embedded in the application software or can be streamed from an external source.

After Calvin has finished watching the video, he can click the “OK” button (in FIG. 8i) to move on. Hobbes can ask Calvin for his feedback on the video, e.g., by asking “Was this video helpful”? (shown in the callout box in FIG. 8j). This allows the application to fine-tune the content offered in the future to recommend the most helpful lessons based on the individual student's preferences.

As shown in FIG. 8k, Hobbes offers additional alternative practice to help Calvin get ready for the homework assignment. Again, this is optional depending on if Calvin wants that extra help. For example, Hobbes can offer a math game as an example of an alternative method of learning, as shown in FIG. 81. If Calvin clicks “OK” (in FIG. 81), then the application takes Calvin to a math game interface (shown in FIG. 8m) where Calvin can play the game. When Calvin is done with the game, he can click “OK” (in FIG. 8m), and then Hobbes gets Calvin ready for the homework and lets Calvin know that he can check answers (FIG. 8n). For example, a tool such as Wolfram Alpha can be used as an answer checking tool (in FIG. 8o), which allows Calvin to check his work as he goes or if he gets stuck. An option may exist to lock out this feature if a parent or teacher does not want Calvin to have access to such a tool. Again, feedback can be solicited for this tool to tune the application software to what works best for Calvin's learning preferences and effectiveness (as shown in FIG. 8p).

When Calvin has completed the Math assignment, the application can check other scheduled tasks for Calvin and prompt Calvin to start work early enough for effective study (FIG. 8q). For example, if there is an English assignment due the following week, the application can prompt Calvin to start the work now (FIG. 8r). This can be especially useful for a student with weak planning skills. Suppose the English assignment is regarding a book report assignment on Harry Potter, the application can first show Calvin some information on how to write a good book report (FIG. 8s). For example, the application can provide a book report outline tool (see FIG. 8t) to give Calvin a template to start with. The application can also help by finding good research resources for Calvin. For example, as shown in FIG. 8u, Hobbes can ask Calvin whether he wants to check out some great websites about Harry Potter. In FIG. 8v, Calvin can be presented with options: “Harry Potter Interactive” and “Harry Potter Information.” FIG. 8w shows a website having relevant Harry Potter pages.

Suppose Calvin also has a History exam in four days. The application can help by offering Calvin a reminder so that he will not wait to study the subject until the last minute (see FIG. 8x). The application can further offer different study routes by asking Calvin certain preliminary questions, such as whether he remember the topic (FIG. 8y). If Calvin selects “I don't remember anything” (on FIG. 8y), the application can direct Calvin to a website to familiarize himself with the subject (FIG. 8z). For example, the application may present a quiz site about the Civil War (see FIG. 8z-1).

The application can also ask Calvin to look through his book to see what he wants to cover (see FIG. 8z-2). As homework wraps up, the application can check the calendar for other types of future events or tasks scheduled, and give Calvin a “heads-up” on upcoming events (see FIG. 8z-3). For example, the application can remind Calvin about a school trip next Friday, and ask Calvin whether he wants to look into it (FIG. 8z-4). If Calvin answers yes, the application can present a page containing information about the school trip destination (FIG. 8z-5).

After Calvin is finished with the homework, the application can offer some final reminders about upcoming events in Calvin's sports and social tracks. For example, Hobbes may remind Calvin about the practice tomorrow, and the party on the weekend (FIG. 8z-6)

Although certain embodiments of the invention have been shown and described, many features may be varied, as will readily be apparent to those skilled in this art. For example, the embodiments of the software application and GUIs can be adapted to manage a variety of projects for the user, such as financial planning or management (e.g., stock/bond/funds investment, expense management, etc.), professional development (e.g., training, coaching, vocational education, etc.), personal or family projects (e.g., vacation, holiday gathering, etc.). Thus, the foregoing description is illustrative and not limiting.

What is claimed is:

1. A computer-implemented method for facilitating the management of a user's project, comprising:
on a display of a computing device, presenting a graphic user interface (GUI) including one or more project tracks of a user, each track having a time dimension and including one or more objects positioned along the time dimension;
on the display of the computing device, presenting a user interaction component, the user interaction component interacting with the user and prompting the user for inputs, which inputs are then used to modify information displayed to the user.

2. The method of claim 1, wherein at least one of the project tracks is a life curriculum of the user.

3. The method of claim 1, wherein at least one of the project tracks is a school course track.

4. The method of claim 1, wherein the one or more project tracks are linked to data sources and are automatically updated according to a predefined schedule.

5. The method of claim 1, further comprising:
receiving an input from the user for creating or modifying one of the plurality of objects of the one or more project tracks.

6. The method of claim 1, wherein the user interaction component includes an AI agent configured to be an avatar selectable by the user.

7. The method of claim 6, wherein the user interaction component further includes an AI GUI shaped as a callout box associated with the AI agent.

8. The method of claim 1, further comprising:
the user interaction component providing a reminder regarding a future event relating to the one or more tracks to the user.

9. The method of claim 1, further comprising:
in response to a user input regarding performing a task on the one or more project tracks, the user interaction component providing one or more options related to the task for the user to select.

10. The method of claim 9, further comprising:
in response to the user selection of one of the one or more options, the user interaction component directing the user to an environment in which an action of the selected option can be performed.

11. The method of claim 9, wherein the content of at least one of the options is provided by a content provider.

12. The method of claim 1, wherein the objects on the project tracks represent tasks or events for the user, the method further comprising:
on the display of the computing device, presenting a consolidated view of a plurality objects, the plurality of objects including at least a first object from a first project track and at least a second object from a second project track, the plurality of objects arranged according to the priority of the tasks or events represented by the respective objects.

13. A system comprising:
a display,
a computer processor and a memory associated with the processor, the memory storing programmed instructions which, when executed by the processor, cause the processor to:
present, on the display, a graphic user interface (GUI) including one or more project tracks of a first user, each track having a time dimension and including one or more objects positioned along the time dimension; and
present, on the display, a user interaction component configured to interact with the first user to manage the first user's project tracks and prompt the user for inputs, which inputs are then used to modify information displayed to the user.

14. The system of claim 13, wherein at least one of the project tracks is a school course track.

15. The system of claim 13, wherein the one or more project tracks are linked to data sources and are automatically updated according to a predefined schedule.

16. The system of claim 13, wherein the user interaction component is configured to provide an option for the first user to create or modify an object on one of the project tracks.

17. The system of claim 13, wherein the user interaction component includes an AI agent configured to be an avatar selectable by the first user.

18. The system of claim 17, wherein the user interaction component further includes an AI GUI shaped as a callout box associated with the AI agent.

19. The system of claim 13, wherein the user interaction component is configured to provide a reminder regarding a future event relating to the one or more tracks to the first user.

20. The system of claim 13, wherein the user interaction component is configured to:
in response to a user input regarding performing a task, provide one or more options related to the task for the first user to select.

21. The system of claim 20, wherein the user interaction component is configured to:
in response to the user selection of one of the one or more options, direct the first user to an environment in which an action of the selected option can be performed.

22. The system of claim 20, wherein the content of at least one of the options is provided by a content provider.

23. The system of claim 13, wherein the system is configured to allow a second user to create or modify an object on one or more project tracks of the first user.

24. The system of claim 13, wherein the display, the processor, and the memory are included in a user computing device.

25. The system of claim 13, wherein the display is included in a user computing device, and the processor and the memory are included in a remote server computer being networked with the computing device.

26. The system of claim 13, wherein the one or more project tracks of the first user are initially obtained by or for the first user from a content provider.

27. A computer-implemented method for facilitating the management of a user's project, comprising:
on a display of a computing device, presenting a graphic user interface (GUI) including one or more project tracks of a user, each track having a time dimension and including one or more objects positioned along the time dimension;
on the display of the computing device, presenting a user interaction component, the user interaction component:
in response to a user input regarding performing a task on the one or more project tracks, providing one or more options related to the task for the user to select, and
in response to the user selection of one of the one or more options, directing the user to an environment in which an action of the selected option can be performed.

28. A system comprising:
a computing device accessible by a user, the computing device having a display;
a remote server being networked with the computing device, the remote server including a computer processor and a memory associated with the processor, the memory storing programmed instructions which, when executed by the processor, cause the processor to:
generate, and transmit to the computing device for display, a graphic user interface (GUI) including one or more project tracks, each track has a time dimension and including one or more objects positioned along the time dimension; and
generate, and transmit to the computing device for display, a user interaction component, the user interaction component including an AI agent configured to be an avatar selectable by the user, and an AI GUI shaped as a callout box associated with the AI agent, the user interaction component further configured to:
in response to a user input regarding performing a task on the one or more project tracks, provide one or more options related to the task for the user to select, and
in response to the user selection of one of the one or more options, direct the user to an environment in which an action of the selected option can be performed.
